(19) United States
(12) Patent Application Publication
(10) Pub. No.: US 2019/0219040 A1
(43) Pub. Date: Jul. 18, 2019

(54) TORQUE AMPLIFICATION METHOD USING PISTON

(71) Applicant: Taesoo SHIIN, Gunsan (KR)

(72) Inventor: Taesoo SHIIN, Gunsan (KR)

(21) Appl. No.: 16/326,173

(22) PCT Filed: Aug. 14, 2017
(86) PCT No.: PCT/KR2017/008846

§ 371 Date: Feb. 15, 2019

(30) Foreign Application Priority Data
Aug. 16, 2016 (KR) 10-2016-0103829

(51) Int. Cl. F03G 7/08; F03G 7/10

(52) U.S. Cl. CPC F03G 7/08; F03G 7/10

(57) ABSTRACT

For example, in FIG. 1, when any one of two arrows on the top of wheel supports 12 or any region on the top of the wheel supports 12 is pressed with a force of 100 [N] , the displayed value of a platform scale 14 is the same and indicates 100 [N]. As shown in FIG. 2, for example, when a motor arm coupling bolt 30 spaced by a distance of 0.3 m from a motor shaft 26 is pressed clockwise with a force of 100 [N], the same force is transmitted to a generator arm coupling bolt 29 spaced by a distance of 0.5 m from the motor shaft 26 located at the left end of a left wheel support 28 through a lower ½ ring type wheel support 24. In this case, torque generated in the motor arm coupling bolt 30 is obtained as follows: τ=force×arm length=100×0.3=30 [N·m], and torque generated in the generator arm coupling bolt 29 is obtained as follows: τ=100×0.5=50 [N·m]. Thus, since 50/30=1.66, torque is amplified about 1.66-fold. The output is obtained as follows: P=rate of rotation×torque=ω×τ[w]. Thus, when the rate of rotation is the same and the torque is amplified 1.66-fold, the output may also be amplified 1.66-fold.

### TECHNICAL FIELD

The present invention relates to a method of amplifying torque using a piston.

### BACKGROUND ART

Searching for information on “perpetual mobile” or “infinite power” on the Internet, it can be seen that numerous attempts have been made to implement “perpetual mobile” or “infinite power” and that such attempts have failed. To date, there is no device or method capable of amplifying the torque of a prime mover such as a motor without increasing input at the same rate of rotation.

### DISCLOSURE

### Technical Problem

Therefore, the present invention has been made in view of the above problems, and it is one object of the present invention to provide a method of amplifying the torque of a prime mover such as a motor or a diesel engine without increasing the input of the prime mover at the same rate of rotation.

### Technical Solution

In accordance with one aspect of the present invention, provided is a method of amplifying torque. According to the method of the present invention, the end of a motor arm is coupled to the center of the top and bottom of the inner side of the wheel support and the end of a generator arm is coupled to the center of the top and bottom of the outer side of the wheel support. In this configuration, rotation is performed, and the output torque of a prime mover such as a motor is amplified.

### Advantageous effects

According to the present invention, the torque of a prime mover can be amplified without increasing the input of the prime mover. That is, the output of the prime mover can be amplified without extra energy input. Therefore, it is expected that about 70% to 80% of problems, such as environmental pollution and climate change due to use of fossil energy and increase in energy demand due to population growth, can be solved.

### MODE FOR INVENTION

For example, in FIG. 1, when any one of two arrows on the top of wheel supports 12 or any region on the top of the wheel supports 12 is pressed with a force of 100 [N], the displayed value of a platform scale 14 is the same and indicates 100 [N].

As shown in FIG. 2, for example, when a motor arm coupling bolt 30 spaced by a distance of 0.3 m from a motor shaft 26 is pressed clockwise with a force of 100 [N], the same force is transmitted to a generator arm coupling bolt 29 spaced by a distance of 0.5 m from the motor shaft 26 located at the left end of a left wheel support 28 through a lower ½ ring type wheel support 24.

In this case, torque generated in the motor arm coupling bolt 30 is obtained as follows: τ=force×arm length=100×0.3=30 [N·m], and torque generated in the generator arm coupling bolt 29 is obtained as follows: τ=100×0.5=50 [N·m].

Thus, since 50/30=1.66, torque is amplified about 1.66-fold.

The output is obtained as follows: P=rate of rotation×torque=ω×τ[w].

Thus, when the rate of rotation is the same and the torque is amplified 1.66-fold, the output may also be amplified 1.66-fold.

For example, a 10 horsepower motor may operate at 16.6 horsepower at the same rate of rotation without increasing the input of the motor.

Considering 1.66-fold for one unit, when two or more units are connected or coupled in series, torque may be amplified 2.75 times or more (i.e., 1.66×1.66=2.75).

Although a motor is used as a prime mover in the present invention, other types of prime movers other than the motor may also be used.

In addition, although an iron plate is used in the present invention, other materials other than the iron plate may be used according to the design, and a fixing bolt may be replaced with a round bar.

In addition, although a generator is used as a rotating load, the present invention is not limited to the generator.

Upper and lower return springs 31 of the motor arm coupling bolt 30 are installed on a supporting square iron plate 25 (not shown) so that a ring type rotation body 22 is always positioned at a certain position with respect to the motor arm coupling bolt 30.

Since the ½ ring type support 24 is provided on the upper and lower sides, torque may be amplified in both the clockwise and counterclockwise directions.

A general piston and cylinder capable of moving up and down smoothly between the supporting square iron plate and the supporting small semicircular iron plate 32 coupled to the ring type rotation body 22 like the wheel support 28 may be used as alternatives.

The points at which the ½ ring type support 24 contacts the upper and lower ends of the wheel support 28 may be cut out to a depth of about 3 to 5 times the width of the ½ ring type support 24.

The ring type rotation body 22 having a diameter of about 0.5 m or less, the supporting square iron plate 25, and the supporting small semicircular iron plate 32 may be manufactured in an integral type by machining a thick iron plate with a machine tool such as a CNC lathe, or in the case of a diameter larger than that, these components may be manufactured separately and assembled together.

In the integral type, a circular iron plate is preferably installed at the front side of the ring type rotation body 22.

The left and right wheel supports 28 are fixed using the generator arm coupling bolt 29 and the motor arm coupling bolt 30 so that the position of the wheel supports is not changed left and right or back and forth. In addition, a groove of a depth of 1 to 5 mm that is 0.3 to 0.5 mm longer than the width of the wheel may be formed up and down on the surface contacting the wheel of the wheel support 28 between the supporting square iron plate 25 and the supporting small semicircular iron plate 32.

1. The method of amplifying torque, in which a ring type rotation body (22) and a supporting square iron plate (25) are placed on a rear circular iron plate, wheel supports (28) each having two or more wheels are respectively disposed on left and right sides between the supporting square iron plate (25) and a supporting small semicircular iron plate (32), opposite ends of each of ½ ring type supports (24) each having two or more wheels are arranged so as to be in contact with a central portion of upper and lower surface of the left and right wheel supports(28), a generator arm coupling bolt (29) is coupled to a generator arm, a motor arm coupling bolt (30) is coupled to a motor arm, and torque of a motor is amplified by rotation of a motor.
